(19) United States
(12) Patent Application Publication
(10) Pub. No.: US 2024/0078561 A1
(43) Pub. Date: Mar. 7, 2024

(54) METHOD AND SYSTEM FOR AGRICULTURAL GREENHOUSE GAS ESTIMATION

(71) Applicant: Royal Bank of Canada, Toronto (CA)

(72) Inventors: Cogie Cogan, London (CA); Yixin Tian, Toronto (CA); Vicki Chen, Toronto (CA); Myles MacDonald, Mississauga (CA); Graham Alexander Watt, Toronto (CA); Arthur Berrill, Goodwood (CA); Melissa Lynne Paxton, Burlington (CA); Daniel Gilles Foisy, Pickering (CA); Po Lun Law, Toronto (CA)

(21) Appl. No.: 18/453,170

(22) Filed: Aug. 21, 2023

Related U.S. Application Data
(60) Provisional application No. 63/400,690, filed on Aug. 24, 2022.

(51) Int. Cl. G06Q 30/018; G06Q 50/02

(52) U.S. Cl. CPC G06Q 30/018; G06Q 50/02

(57) ABSTRACT

Methods, systems, and techniques for agricultural greenhouse gas estimation. Farm data in the form of at least one of revenue generated by a farm, crop information for one or more crops grown on the farm, and land use/farm practice data for land used on the farm to grow the one or more crops is obtained. An emissions estimate is determined based on the obtained data and caused to be displayed to the user via a graphical user interface. A user may be a person responsible for managing multiple farms. That user may be presented with aggregate emissions-related information for all farms, including projected future emissions under various scenarios, and may also iteratively experiment with different farm data values in order to attempt to reduce projected emissions or increase data quality/emissions estimate accuracy.

### CROSS-REFERENCE TO RELATED APPLICATION

The present application claims priority to U.S. provisional patent application No. 63/400,690 filed on Aug. 24, 2022, and entitled “Method and System for Agricultural Greenhouse Gas Estimation”, the entirety of which is hereby incorporated by reference herein.

### TECHNICAL HELD

The present disclosure is directed at methods, systems, and techniques for agricultural greenhouse gas estimation.

### BACKGROUND

Global warming is generally recognized as a significant societal problem. A material contributor to global warming is agricultural greenhouse gas emissions. According to the U.S. Department of Agriculture for example, in 2020 U.S. agriculture alone was responsible for 669.5 million metric tons of carbon-dioxide equivalent: 50.5% as nitrous oxide, 37.5% as methane, and 12.0% as carbon dioxide. Collectively, this represented 11.2% of all U.S. emissions in 2020. Developing methods to estimate, with a view to reducing, agricultural emissions accordingly is desirable.

### SUMMARY

According to a first aspect, there is provided a method comprising: obtaining at least one of: revenue generated by a farm; crop information for one or more crops grown on the farm; and land use/farm practice data for land used on the farm to grow the one or more crops; receiving, from a user, a selection of which emissions estimate to determine based on the at least one of the revenue generated by the farm, the crop information for the one or more crops grown on the farm, and the land use/farm practice data for land used on the farm to grow the one or more crops; determining the emissions estimate in response to the selection by the user; and causing the emissions estimate that is determined in response to the selection by the user to be displayed to the user.

The method may further comprise obtaining financial information comprising an outstanding amount owing on the farm to a financial institution, total equity in the farm, and total debt on the farm, and the emissions estimate may be expressed as a financed emissions estimate based on the financial information.

The financial information may be obtained from a financial institution database.

The method may further comprise: obtaining weather information customized for a location of the farm; determining a climate insight for the farm based on the weather information; and causing the climate insight to be displayed to the user.

The method may further comprise: obtaining weather information customized for a location of the farm: determining a practice insight for the farm based on the weather information; and causing the practice insight to be displayed to the user.

Obtaining the weather information may comprise retrieving the weather information over a wide area network using an application programming interface.

The emissions estimate may be based on the revenue generated by the farm and be displayed to the user, and the method may further comprise: receiving the crop information for the one or more crops grown on the farm; in response to receiving the crop information, determining the emissions estimate based the crop information; and causing the emissions estimate determined in response to receiving the crop information to be displayed to the user.

The emissions estimate may be based on the crop information and be displayed to the user, and the method may further comprise: receiving the land use/farm practice data for land used on the farm to grow the one or more crops; in response to receiving the land use/farm practice data, determining the emissions estimates based on the land use/farm practice data; and causing the emissions estimate determined in response to receiving the land use/farm practice data to be displayed to the user.

According to another aspect, there is provided a system comprising: one or more databases; and one or more servers configured to: obtain at least one of: from the one or more databases, revenue generated by a farm; crop information for one or more crops grown on the farm; and land use/farm practice data for land used on the farm to grow the one or more crops; receive, from a user device, a selection of which emissions estimate to determine based on the at least one of the revenue generated by the farm, the crop information for the one or more crops grown on the farm, and the land use/farm practice data for land used on the farm to grow the one or more crops; determining the emissions estimate in response to the selection from the user device; and cause the emissions estimate that is determined in response to the selection be displayed on the user device.

According to another aspect, there is provided a method for estimating agricultural greenhouse gas emissions, the method comprising: obtaining farm data comprising at least one of: revenue generated by a farm; crop information for one or more crops grown on the farm; and land use/farm practice data for land used on the farm to grow the one or more crops; determining an emissions estimate in response to the farm data; and causing the emissions estimate that is determined to be displayed to a user.

The method may further comprise receiving, from the user, a selection of which of multiple emissions estimates to determine based on the at least one of the revenue generated by the farm, the crop information for the one or more crops grown on the farm, and the land use/farm practice data for land used on the farm to grow the one or more crops, and the emissions estimate that is determined may be the emissions estimate selected by the user.

The method may further comprise obtaining financial information comprising an outstanding amount owing on the farm to a financial institution, total equity in the farm, and total debt on the farm, and the emissions estimate may be expressed as a financed emissions estimate based on the financial information and on total emissions representative of emissions financed by the financial institution.

At least some of the financial information may be automatically retrieved from a database of a financial institution that is a creditor of the farm.

The farm data may comprise the land use/farm practice data, and determining the emissions estimate may comprise determining at least one of: direct N₂O emissions from nitrogen from synthetic sources applied to the one or more crops; direct N₂O emissions from nitrogen from organic fertilizer applied to the one or more crops; direct and indirect N₂O emissions from nitrogen from manure applied to the one or more crops; indirect N₂O emissions from nitrogen from biosolids applied to the one or more crops; and N₂O emissions from organic cultivation of soil used to grow the one or more crops. Determining the emissions estimate may comprise determining all of the foregoing N₂O emissions sources.

Determining the emissions estimate may further comprise determining at least one of: indirect N₂O emissions from agricultural soils used to grow the one or more crops; CH₄ and N₂O emissions from burning crop residues of the one or more crops; and CO₂ emissions from liming and urea applied to the one or more crops.

The farm data may comprise the crop information and exclude the land use/farm practice data, and determining the emissions estimate may comprise summing the emissions attributable to each of the one or more crops.

The farm data may comprise the revenue generated by the farm and exclude the land use/farm practice data and the crop information, and determining the emissions estimate may be performed using the revenue.

The method may further comprise: obtaining, via a wide area network using an application programming interface, weather information customized for a location of the farm; determining a climate insight for the farm based on the weather information, wherein the climate insight comprises at least one of current and forecasted levels of precipitation in respect of the farm, air temperature at the farm, soil information for the farm, growing degree days for the farm, and years of similar climate or growing conditions to the present or another selected year in respect of the farm; and causing the climate insight to be displayed to the user.

The method may further comprise: obtaining, via a wide area network using an application programming interface, weather information customized for a location of the farm; determining a practice insight for the farm based on the weather information, wherein the practice insight comprises a recommended farming practice; and causing the practice insight to be displayed to the user.

The method may further comprise determining and displaying to the user a cost of implementing the practice insight.

The crop information may comprise at least one of crop type, crop sub-type, and for each type or sub-type at least one of yield, year, acres, fertilizer type, whether an herbicide is used and if so an application rate of the herbicide, and whether the farm is irrigated.

The land use/farm practice data may comprise at least one of past tillage, current tillage, year the past tillage changed to the current tillage, whether there is a perennial crop increase, past percentage of perennial forage, year that perennial forage percentage changed, grass land broken, and organic soil area, soil texture, soil moisture, and soil pH.

The method may further comprise: receiving, from the user, different values for the farm data; in response to each of the different values of the farm data, respectively determining different iterations of the emissions estimate; and displaying each of the different iterations of the emissions estimate to the user.

Accuracy of the emissions estimate may be lowest when based only on the revenue and highest when based on the land use/farm practice data, the different iterations may comprise first and second iterations that are based on different types of the farm data, and the emissions estimate of the second iteration may be more accurate than the emissions estimate of the first iteration.

The farm may be one of a plurality of farms, and the method may further comprise displaying to the user aggregated emissions data based on the plurality of farms, and the aggregated emissions data may comprise a graph representing projected emissions for the plurality of farms under different Representative Concentration Pathway scenarios.

Accuracy of the emissions may be estimate lowest when based only on the revenue and highest when based on the land use/farm practice data, the farm may be one of a plurality of farms, and further comprising displaying to the user a graph of data quality score breakdown indicating aggregate accuracy of the emissions estimates across the plurality of farms.

According to another aspect, there is provided a system for estimating agricultural greenhouse gas emissions, the system comprising: a display; and one or more servers communicatively coupled to the one or more databases and the display, and configured to: obtain farm data comprising at least one of: revenue generated by a farm; crop information for one or more crops grown on the farm; and land use/farm practice data for land used on the farm to grow the one or more crops; determine an emissions estimate in response to the farm data; and cause the emissions estimate that is determined to be displayed to a user on the display.

According to another aspect, there is provided a non-transitory computer readable medium having stored thereon computer program code that is executable by a processor and that, when executed by the processor, causes the processor to perform the foregoing method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a network diagram illustrating one architecture used to implement a system for agricultural greenhouse gas estimation, according to an example embodiment.

FIG. 2 is a block diagram of a server comprising part of the architecture of FIG. 1.

FIG. 3 is a logical block diagram illustrating the architecture of and connections between a frontend and a backend of a system for agricultural greenhouse gas estimation, according to an example embodiment.

FIG. 4 is a flowchart illustrating a method for estimating agricultural greenhouse gas estimation, according to an example embodiment.

FIG. 5 is a flowchart illustrating a method for determining how to reduce agricultural greenhouse gas estimation, according to an example embodiment.

FIG. 6 is a flowchart illustrating a method for interacting with a system for estimating agricultural greenhouse gas estimation, according to an example embodiment.

FIGS. 7A and 7B are an entity relationship diagram for a database comprising part of a system for estimating agricultural greenhouse gas estimation, according to an example embodiment.

FIG. 8 shows a screenshot of a dashboard displayed on a user device comprising part of a system for agricultural greenhouse gas estimation, according to an example embodiment.

FIG. 9 shows a screenshot of a farm profile displayed on a user device comprising part of a system for agricultural greenhouse gas estimation, according to an example embodiment.

FIGS. 10A-10D collectively show a screenshot of a data input form displayed on a user device comprising part of a system for agricultural greenhouse gas estimation, according to an example embodiment.

### DETAILED DESCRIPTION

Part of applying environmental, social, and governance (“ESG”) principles is investing in and supporting businesses that make efforts to manage and reduce their greenhouse gas (“GHG”) emissions. In view of this, at least some of the embodiments described herein are directed at estimating GHG emissions in the agricultural industry. Information relevant to agricultural GHG emissions, such as real-time location-based information such as temperature and precipitation, are obtained and used to estimate GHG emissions of a piece of agricultural land such as a farm. In some cases, recommendations may also be made regarding how to reduce estimated emissions.

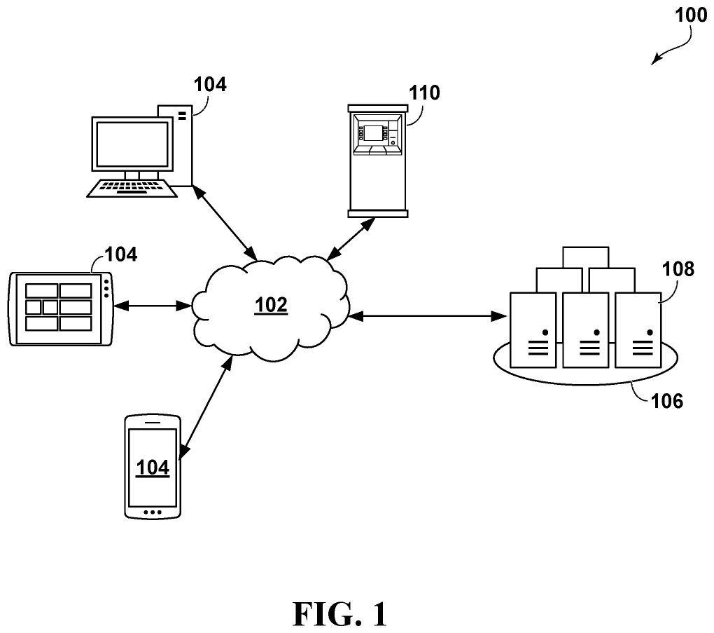

Referring now to FIG. 1, there is shown a computer network 100 that comprises an example embodiment of a system for agricultural greenhouse gas estimation. More particularly, the computer network 100 comprises a wide area network 102 such as the Internet to which various user devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit clients to log in to those servers using client accounts that give them access to various computer-implemented banking services, such as online fund transfers. Furthermore, individuals may appear in person at the ATM 110 to withdraw money from bank accounts controlled by the data center 106.

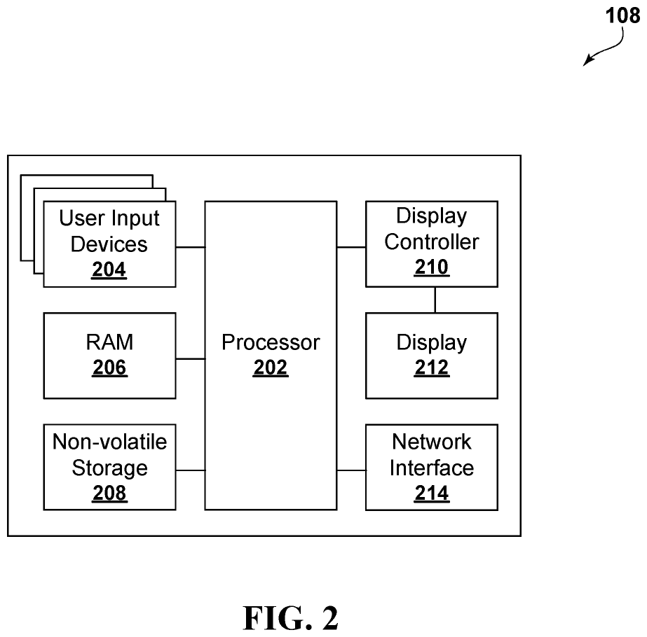

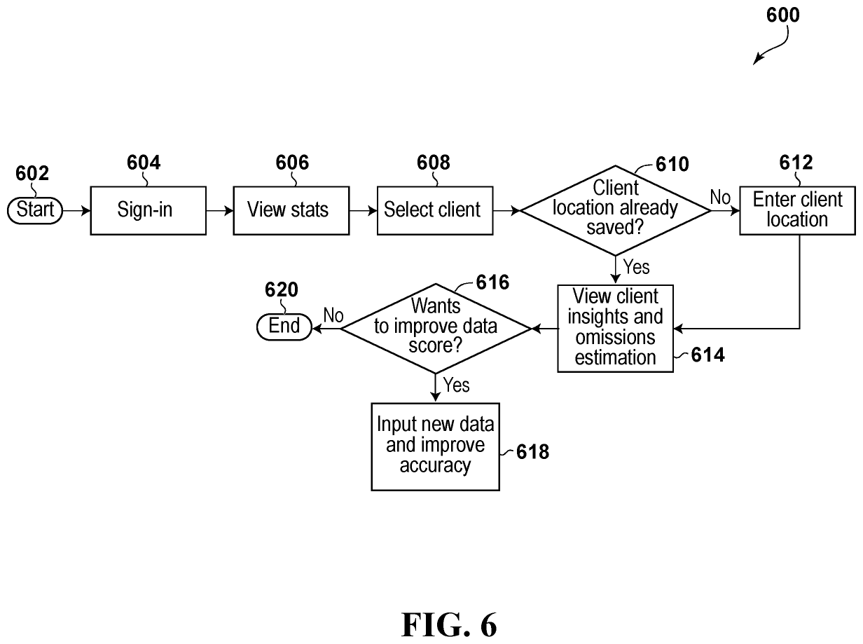

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for agricultural greenhouse gas estimation such as is described in more detail in respect of FIG. 6 below. Additionally or alternatively, the servers 108 may collectively perform that method using distributed computing. While the system depicted in FIG. 2 is described specifically in respect of one of the servers 108, analogous versions of the system may also be used for the user devices 104.

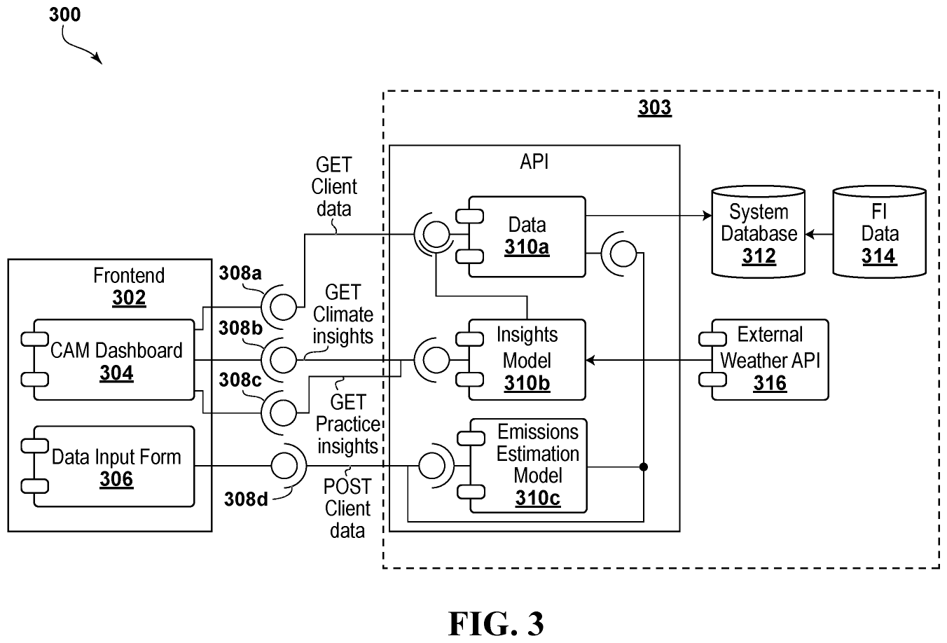

Referring now to FIG. 3, there is shown is a logical block diagram illustrating the architecture of and connections between a frontend 302 and a backend 303 of a system 300 for agricultural greenhouse gas estimation, according to an example embodiment. The frontend 302 may be implemented on one of the user devices 104, and comprises a dashboard 304 that displays on the user device 104 client data, climate insights, and emissions estimations. Example users of the system 300 comprise clients in the form of farmers of agricultural land (“farm”), and a client account manager (“CAM”) associated with the farmer's financial institution. While in the examples below the farm is a crop farm, in at least some other embodiments the farm may additionally or alternatively farm something other than crops, such as livestock or dairy.

Example types of client data comprise crop activity, land usage information, emissions information, and financial information. Climate insights are tied to the location of the farm and comprise current and forecasted levels of precipitation in respect of the farm, air temperature at the farm, soil information (e.g., temperature, wetness, type) for the farm, and other agricultural measures relevant to the farm (e.g., growing degree days, years of similar climate and/or growing conditions to the present year or another selected year in respect of the farm). Example emissions estimations information comprises farmer-level emission target projections based on various Representative Concentration Pathway (“RCP”) scenarios (as adopted by the United Nations' Intergovernmental Panel on Climate Change) and a 5/4/3/2 carbon emission estimator, with estimates at score 5 being the least accurate and emissions at score 2 being the most accurate as discussed further below.

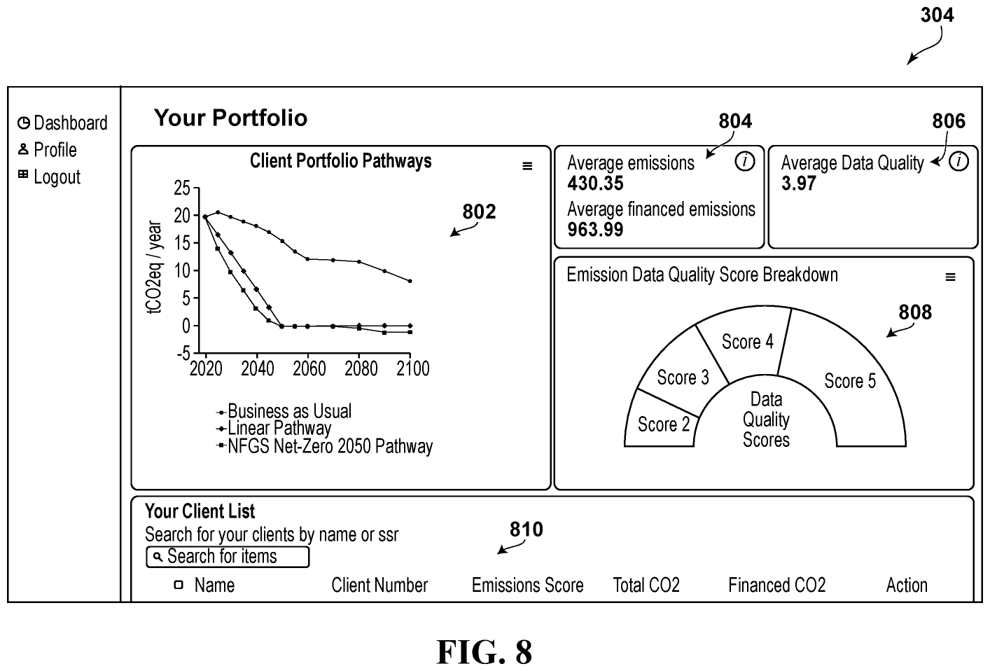

An example dashboard 304 is depicted in FIG. 8. The dashboard 304 of FIG. 8 is for display to a CAM; consequently, the dashboard represents multiple farmers and their respective farms in the CAM's portfolio. The dashboard 304 shows an aggregate portfolio pathways graph 802, showing various RCP scenarios representing an aggregate of the farms comprising the CAM's portfolio; average emissions information 804, showing average emissions and average financed emissions across the portfolio, wherein financed emissions are the indirect greenhouse gas emissions attributable to the financial institution due to its involvement in providing financing to the farm; an average data quality score 806 across the portfolio, representing whether the emissions estimate is a score 5, 4, 3, or 2; a data quality score graph 808 visually representing the average data quality score across the portfolio; and a client list 810 comprising a list of the farms and farmers comprising the CAM's portfolio.

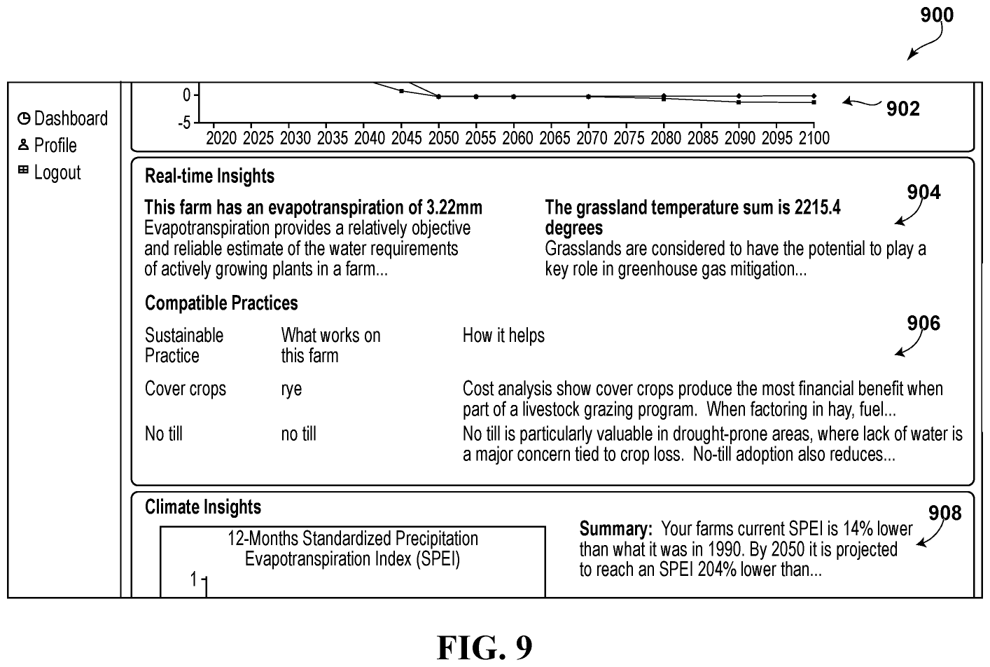

The frontend 302 may also comprise a farm profile 900, as shown in FIG. 9. The farm profile 900 highlights information pertinent to a particular one of the farms comprising the CAM's portfolio. The farm profile 900 of FIG. 9 comprises a pathways graph 902, which are various RCP scenarios for the farm in question; tailored weather information 904, which comprises weather information specific to the farm's location; practice insights 906, which provide recommended farming practices and costs tailored to the farm's location; and climate insights 908, which provide farm location-specific weather information and forecasts.

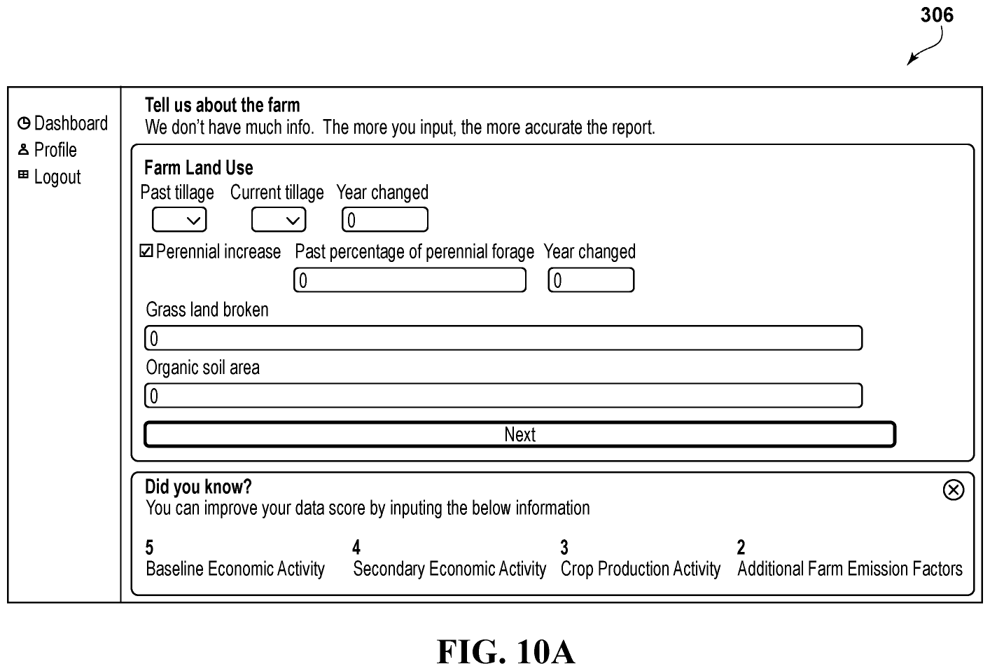

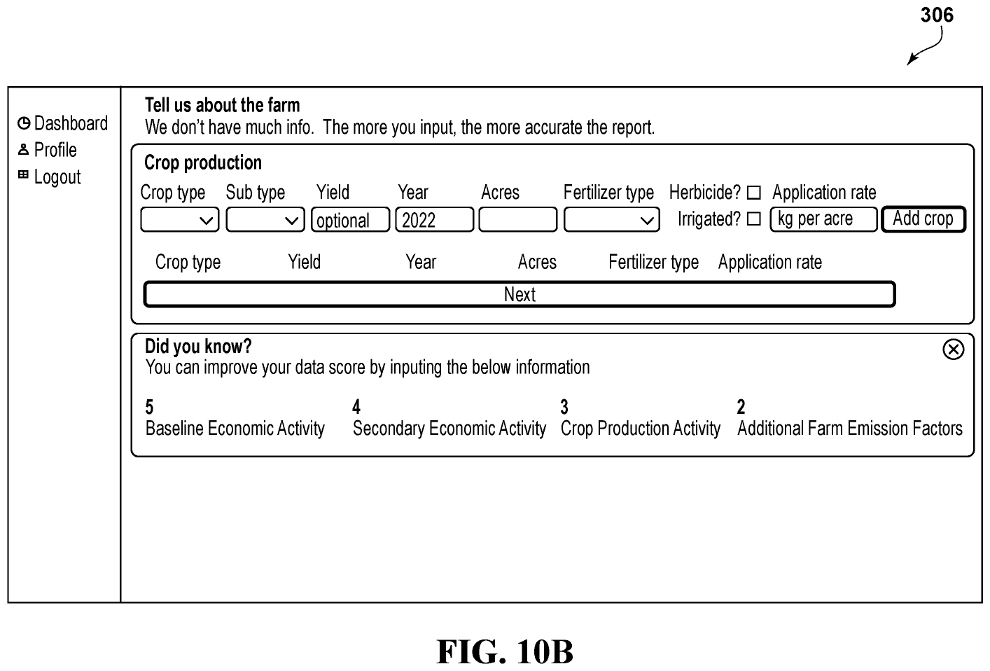

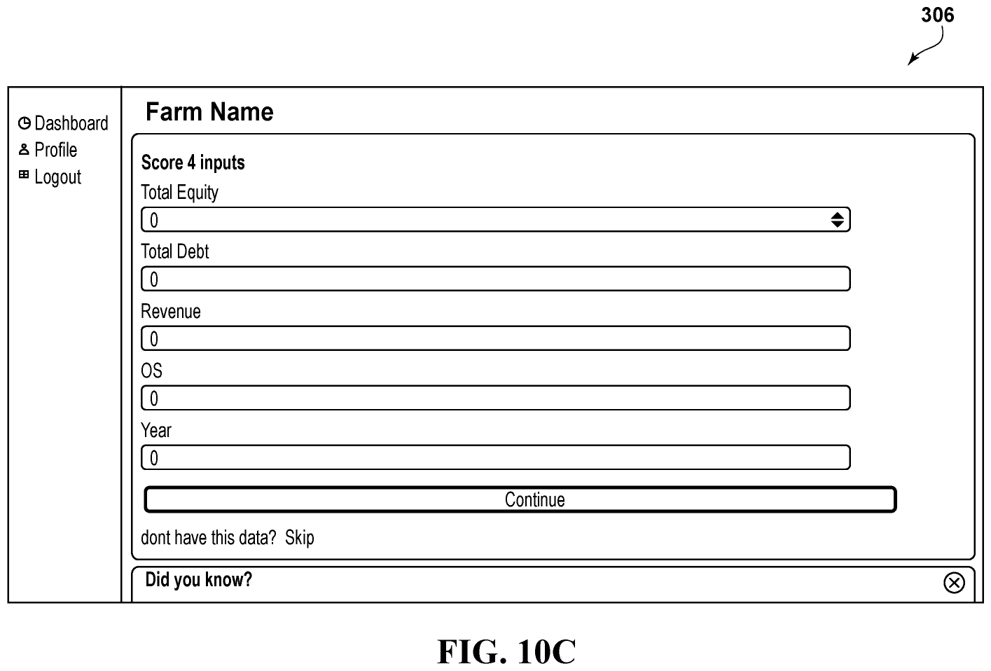

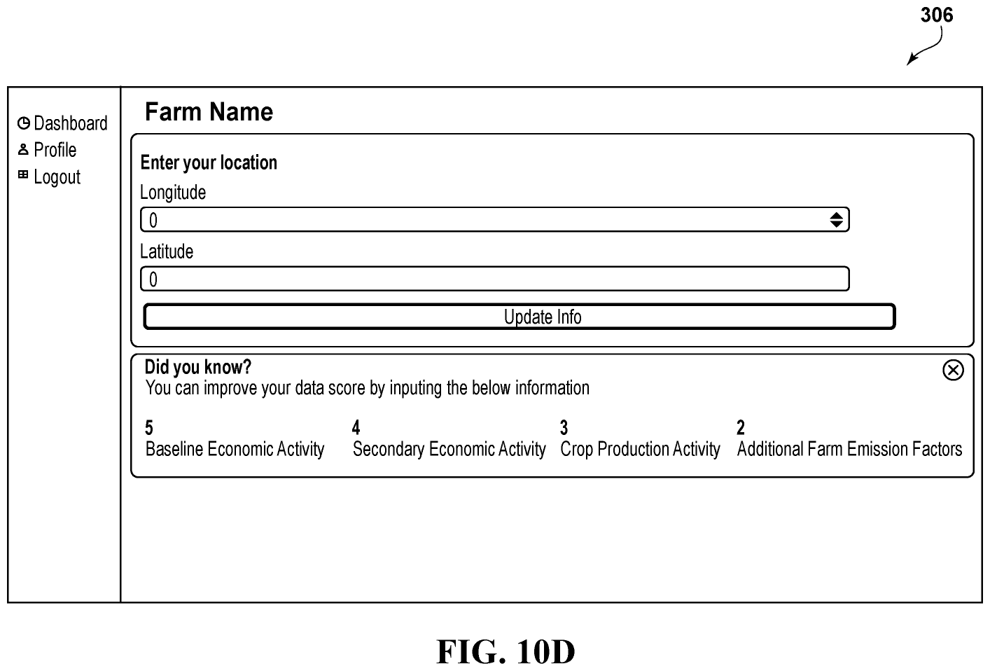

The front end 302 also comprises a data input form 306, such as collectively depicted on FIGS. 10A-10D. The data input form 306 solicits information from the CAM or farmer about a particular farm, such as in respect of:
1. farm land use: past tillage, current tillage, and year changed; whether there is a perennial crop increase; past percentage of perennial forage and the year that perennial forage percentage changed; grass land broken; and organic soil area;
2. crop production: crop type(s) and sub-type(s), and for each type/sub-type, yield, year, acres, fertilizer type, whether an herbicide is used and if so its application rate, and whether the farm is irrigated and if so kg per acre;
3. farm economic information, such as total equity, total debt, revenue, outstanding amounts owing to lenders, and the year to which the economic information applies; and
4. farm location, such as in terms of longitude and latitude.

In FIGS. 10A-10D, the data fields requested in FIG. 10C are for determining score 4 and total financed emissions. As discussed further below, the financial information used in determining score 4 is also used to determine the financed emissions in accordance with scores 2 and 3; the data fields requested in FIG. 10B are used to determine score 3 total emissions; and the data fields requested in FIG. 10A are used to determine score 2 total emissions.

In at least some other embodiments, the data input form 306 may request one or more additional pieces of information from the CAM or farmer, such as the data fields described in Table 1 below. The information in Table 1 may in those other embodiments also be used to determine an emissions estimate.

TABLE 1
Additional Data Fields that May Be Requested via the Data Input Form 306

| Source | Common types of activity data needed |
|---|---|
| General | Soil texture, moisture, drainage and pH |
| | Temperature |
| | Area of different types of crops harvested and crop yield by crop |
| | Location (e.g., state or biome) |
| Enteric fermentation | Livestock numbers by age and type (e.g., calves, bulls, heifers, |
| | cows), disaggregated by season or month |
| | Length of juvenile, adult production and adult non-production |
| | phases |
| | Number of livestock managed off-site (e.g., off-site wintering, |
| | feedlots, agistments) |
| | Sales and purchases of animals |
| | Amount, type and digestibility of feed |
| | Quality of forage in pastures and open grazing systems |
| | Amount of time livestock were grazed |
| | Dry matter intake per head |
| | Type and amount of feed additives |
| Manure management | Type of management system |
| | Amount of manure managed in this system |
| | Number of days system used |
| Application of | Type of fertilizer/farm waste and N content (e.g., % N/kg or liter) |
| synthetic fertilizers, | Application rate (e.g., kg/ha) |
| livestock waste and | Application method (e.g., broadcast, incorporated, etc.) |
| crop residues to soils | Dates of applications |
| | Amount of crop residue returned to soil (including from crop |
| | rotations) |
| | Amounts of exported/imported manure |
| Drainage and tillage | Types of tilling practices |
| of managed soils | Years tilling practices were changed |
| | Area of cropland for which tilling practices were changed |
| | Area of organic soil (e.g., peat, fen) drained to different depths |
| | Soil organic matter (SOM) content |
| Rice cultivation | Crop acreage |
| Open burning of crop | Acres burnt |
| residues | Amount of crop residue left on field per acre |
| Land use change | Land types and species concerned (e.g., type of woodland) |
| | Area of land concerned |
| | Year land use change occurred |
| Woodland management | Volume of harvested wood |
| (e.g., short-rotation | Volume of woody detritus left on-site |
| woody crop plantations) | |

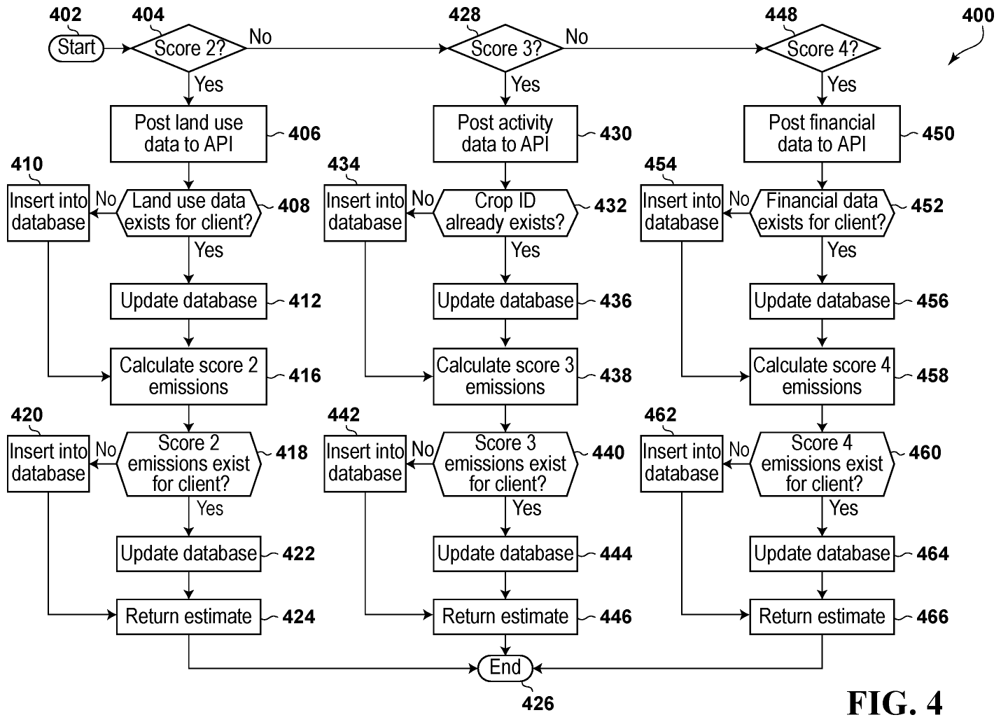

The backend 303 may be implemented on the servers 108 comprising part of the data center 106. The backend 303 comprises a data application programming interface (“API”) 310a, an insights API 310b, and an emissions estimation API 310c. The data API 310a stores and receives user data from a system database 312, and is able to store in the system database 312 all the information sent to the data API 310a as discussed below. The system database 312 is networked with a financial information database (“FI database”) 314, which stores the client's financial information such as outstanding loans and other similar account information. The system database 312 may obtain this information via the data input form 306 and/or the FI database 314. The insights API 310b receives weather data via a weather API 316 that accesses weather information over the wide area network 102 from a third party service, which may be the weather API from Meteomatics™ AG, for example. The emissions estimation API 310c estimates emissions as described further in respect of FIG. 4, below.

As shown in FIG. 3, the dashboard 304 retrieves client data from the system database 312 via the data API 310a by using a first API call 308a; climate insights from the insights API 310b via a second API call 308b; and practice insights from the insights the insights API 310b via a third API call 308c. The user enters data used for emissions estimations into the data input form 306, which sends that data to the emissions estimation API 310c via a fourth API call 308d; as shown in FIG. 3, this data can concurrently be sent to the data API 310a. Internal to the backend 303, the data API 310a can also retrieve emissions estimations directly from the emissions estimations API 310c, and subsequently send them in response to the first API call 308a to the frontend 302 for display on the dashboard 304.

While FIG. 3 depicts three APIs 310a-c, the functionality described in respect of those APIs 310a-c may alternatively be implemented with fewer than three APIs (e.g., a single API) or more than three APIs.

The frontend 302 may be implemented using Angular™, Flowbite™ UI, Tailwind™ CSS, and Highcharts™. The APIs 310a-c may be implemented using Flask™ and Python™. The system database 312 may be implemented using PostgreSQL™.

Referring now to FIG. 4, there is shown a flowchart illustrating a method 400 for estimating agricultural greenhouse gas estimation, according to an example embodiment. The method 400 may be implemented using the system 300 of FIG. 3 and, more particularly, be implemented by the system 300 to estimate emissions as described above in respect of the emissions estimation API 310c.

The method 400 is able to estimate emissions in any of three independent ways, respectively corresponding to scores 2, 3, and 4. Score 4 is the simplest and last accurate estimate, while score 2 is the more complicated and most accurate estimate. Score 4 uses basic client financial information that the system 300 may retrieve from the FI database 314 to determine total emissions estimation as opposed to only financed emissions. Score 3 uses specific crop information (e.g., crop activity of a farmer, such as acres farmed and yield, taking into account different types of crops the farmer may plant on their farm) that the farmer may provide via the data input form 306, such as the information requested in FIG. 10B. Score 2 takes into account land use/farm practice data (e.g., type of farming practice such as tillage practice) that the farmer may provide via the data input form 306, such as the information requested in FIG. 10A. For all of scores 2, 3, and 4, the farm's financial information as obtained from the FI database 314 is also used. The scores are determined in accordance with the framework established by the Partnership for Carbon Accounting Financials, PCAF (2020), The Global GHG Accounting and Reporting Standard for the Financial Industry, First edition, and the National Inventory Report: Greenhouse Gas Sources and Sinks in Canada, issued by Environment Canada, 2004-2013; issued 2014—by Environment and Climate Change Canada, the entireties of both of which are hereby incorporated by reference.

The system 300 starts performing the method 400 at block 402 and proceeds to block 404, where if the emissions estimate is to be determined in accordance with score 2 the system 300 proceeds down a first branch of the flowchart starting at block 406. If the emissions estimate is not to be determined in accordance with score 2, then the system 300 proceeds to block 428, where if the emissions estimate is to be determined in accordance with score 3 the system 300 proceeds down a second branch of the flowchart starting at block 428. If the emissions estimate is not to be determined in accordance with score 3, then the system 300 proceeds to block 448, where if the emissions estimate is to be determined in accordance with score 4 the system 300 proceeds down a third branch of the flowchart starting at block 448. Based on the information available to the CAM or farmer, they are able to select which of score 2, score 3, or score 4 they wish to have generated.

Down the first branch of the flowchart (score 2), land use/farm practice data is posted to the emissions estimation API 310c via the fourth API call 308d at block 406. If land use data already exists for the client in the system database 312, the land use data is updated (blocks 408 and 412); alternatively, if land use data isn't already in the system database 312, it is inserted into the system database 312 (blocks 408 and 410). The backend 303 then determines the emissions estimate in accordance with score 2 at block 416, as follows:

Financed Emission_{c}=Attribution Factor×Total Emission_{c} (1)

where

$$Attribution {Factor}_{c} = \frac{Outstanding {amount}_{c}}{Total equity + {debt}_{c}} \qquad ( 2 )$$

where Outstanding amount, is the outstanding amount owed to creditors, total equity is the total equity in the farm, and debt_{c} is total debt on the farm, and

$$Total {Emission}_{c} = {\sum }_{i} activity {data}_{i} \times E {F}_{a} \qquad ( 3 )$$

Equation (3) can be expressed as follows:

Total Emission_{c}=Inorganic N×EF_{inorg N}_{₂}_{O}+Organic N×EF_{org N}_{₂}_{O}+Manure N×EF_{MN direct N}_{₂}_{O}+Manure N×EF_{MNindir N}_{₂}_{O}+Biosolids N×EF_{BN indir N}_{₂}_{O}+Agriculture Soils×EF_{AS indir N}_{₂}_{O}+Crop Residue×EF_{CR}+Cultivation of Organic Soil×EF_{COS}+Liming and Urea×EF_{LnU} (4)

where
Inorganic N is amount of Nitrogen (“N”) from synthetic sources (e.g., synthetic N fertilizer) applied to all crops (unit: kg/yr);
EF_{inorg N}_{₂}_{O} is amount of direct N₂O emissions emitted by Inorganic N (units: g N₂O kg⁻¹ N year⁻¹);
Organic N is amount of Nitrogen from organic fertilizer (e.g., bio N fertilizer) applied to all crops (units: kg/yr);
EF_{org N}_{₂}_{O} is amount of direct N₂O emission emitted by Organic N (units: g N₂O kg⁻¹ N year⁻¹);
Manure N is amount of Nitrogen in the form of manure applied to all crops (units: kg/yr);
EF_{MN direct N}_{₂}_{O} is amount of direct N₂O emissions emitted by manure application to crops (units: g N₂O kg⁻¹ N year⁻¹);
EF_{MN indir N}_{₂}_{O} is amount of indirect N₂O emissions emitted by manure application to crops (units: g N₂O kg⁻¹ N year⁻¹);
Biosolids N is amount of Nitrogen applied to all crops through biosolids (units: kg/yr);
EF_{BN indir N}_{₂}_{O} is amount of indirect N₂O emission emitted by biosolids application to crops (units: g N₂O kg⁻¹ N year⁻¹);
Agriculture Soils is agricultural soil Nitrogen (units: kg N);
EF_{AS indir N}_{₂}_{O} is indirect N₂O emissions from agricultural soils, with the emission factor due to volatilization and redeposition of Nitrogen in a wet climate being 0.014 kg N₂O·N/kg N and in a dry climate being 0.0075 kg N₂O·N/kg N, and the emission factor due to leaching/runoff being 0.0075 kg N₂O·N/kg N);
Crop Residue is kilograms of crop residue burned;
EF_{CR} is the amount of CH₄ and N₂O emitted by burning crop residues, with the CH₄ emission factor being 2.7 g CH₄ kg⁻¹ dry matter burnt, and the N₂O emission factor being 0.07 g N₂O kg⁻¹ dry matter burnt;
Cultivation of Organic Soil is area of soil cultivated organically in units of ha/year;
EF_{COS} cos is amount of N₂O emitted by organic cultivation of soil per year (unit: kg N₂O·N/ha·year);
Liming and Urea is lime stone and urea application in kilograms; and
EF_{LnU} is CO₂ emissions from liming and urea fertilization, with the dolomite emission factor being 0.13 Mg C/Mg dolomite applied, the limestone emission factor being 0.12 Mg C/Mg limestone applied, and the urea emission factor being 0.20 Mg C/Mg urea.

While Equation (4) includes a variety of factors, some may be omitted in some embodiments for the sake of simplicity. For example, in at least some embodiments the emissions estimate may be determined absent information on Agriculture Soils, Crop Residue, and Liming and Urea.

If an emissions estimate determined in accordance with score 2 is already in the system database 312, the score is updated (blocks 418 and 422); alternatively, if an emissions estimate determined in accordance with score 2 isn't already in the system database 312, the score is inserted into the system database 312 (blocks 418 and 420). The backend 303 subsequently returns the emissions estimate to the frontend 302 via the first API call 308a for display to the user (block 424) and the method ends at block 426.

Down the second branch of the flowchart (score 3), activity data is posted to the emissions estimation API 310c via the fourth API call 308d at block 430. If activity data already exists for the client in the system database 312, the activity data is updated (blocks 432 and 436); alternatively, if activity data isn't already in the system database 312, it is inserted into the system database 312 (blocks 432 and 434). The backend 303 then determines the emissions estimate in accordance with score 3 at block 438, as follows:

$$Total {Emission}_{c} = {\sum }_{crop} {Area}_{crop} \times E {F}_{crop} \qquad ( 5 )$$

where EF crop is the emission factor of each crop measured in kg CO₂ eq/ha of crop.

Financed emission for score 3 may be determined in accordance with Equations (1) and (2).

If an emissions estimate determined in accordance with score 3 is already in the system database 312, the score is updated (blocks 440 and 444); alternatively, if an emissions estimate determined in accordance with score 3 isn't already in the system database 312, the score is inserted into the system database 312 (blocks 440 and 442). The backend 303 subsequently returns the emissions estimate to the frontend 302 via the first API call 308a for display to the user (block 446) and the method ends at block 426.

Down the third branch of the flowchart (score 4), financial data is posted to the emissions estimation API 310c via the fourth API call 308d at block 450. If financial data already exists for the client in the system database 312, the financial data is updated (blocks 452 and 456); alternatively, if financial data isn't already in the system database 312, it is inserted into the system database 312 (blocks 452 and 454). The backend 303 then determines the emissions estimate in accordance with score 4 at block 458, as follows:

$$Total {Emission}_{c} = {\sum }_{c} \frac{Outstanding {amount}_{c}}{Total equity + {debt}_{c}} \times {Revenue}_{c} \times E {F}_{S 4} \qquad ( 6 )$$

where Revenue s is annual revenue and EF_{S4} is emission factor in tCO₂e/M$ annual revenue (tonnes of CO₂ equivalent/annual revenue in millions), determined in accordance with Equation (7):

$$E {F}_{S 4} = \frac{GHG {emissions}_{s}}{{Revenue}_{s}} \qquad ( 7 )$$

where GHG emissions, and Revenue s respectively refer to GHG emissions and revenue for a particular sector.

Financed emission for score 4 may be determined in accordance with Equations (1) and (2).

If an emissions estimate determined in accordance with score 4 is already in the system database 312, the score is updated (blocks 460 and 464); alternatively, if an emissions estimate determined in accordance with score 4 isn't already in the system database 312, the score is inserted into the system database 312 (blocks 460 and 462). The backend 303 subsequently returns the emissions estimate to the frontend 302 via the first API call 308a for display to the user (block 466) and the method ends at block 426.

While not depicted in FIG. 4, an emissions estimate may also be determined in accordance with score 5, which is less accurate than score 4, in accordance with Equation (8):

$$Financed {Emission}_{c} = {\sum }_{c} Outstanding {amount}_{c} \times E {F}_{S 5} \qquad ( 8 )$$

where Outstanding amount is the amount outstanding owed on the farm to lenders, and EF_{S5} is as defined in Equation (9):

$$E {F}_{S 5} = \frac{GHG {emissions}_{s}}{{Assets}_{s}} \qquad ( 9 )$$

where GHG emissions, and Assetₛ, respectively refer to GHG emissions and assets for a particular sector.

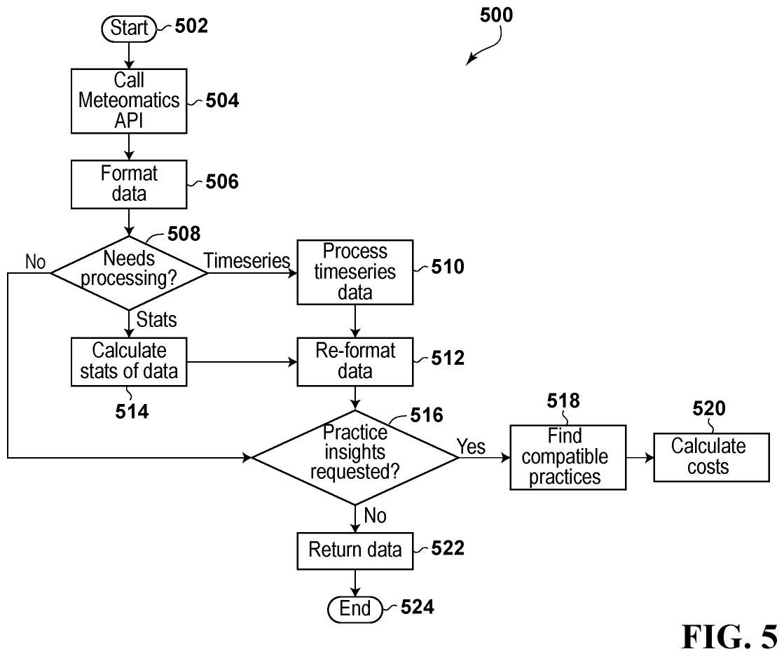

Referring now to FIG. 5, there is shown a flowchart illustrating a method 500 for determining how to reduce agricultural greenhouse gas estimation, according to an example embodiment. The method 500 may be implemented using the system 300 of FIG. 3 and, more particularly, be implemented by the system 300 to provide practice insights as described above in respect of the insights estimation API 310b.

The system 300 begins performing the method 500 at block 502 and proceeds to block 405 where it obtains weather data by calling the weather API 316. The backend 303 uses the weather API 316 to obtain weather data tailored for the farm's location at block 504 and upon receiving the weather data formats it at block 506 (e.g., by removing response headers) so it is suitable for use within the system 300. At block 508 the backend 303 determines whether the weather data needs processing. For example, as discussed further below, if the backend 303 is to obtain data in time series (i.e., historical data over a span of time) or statistical data (e.g., minimum or average data values over a span of time), the backend 303 performs that processing as described below in respect of blocks 510 and 514. If no, the backend 303 proceeds directly to block 516 where it determines whether practice insights have been requested by the user.

Alternatively, if the backend 303 determines the weather data would benefit from time series processing, the backend 303 proceeds to block 510 from block 508 where it performs that processing and then to block 512 where it re-formats the processed data, before proceeding to block 516. Example time series processing done at block 510 may comprise, for example, searching through the weather data, which may be a series of weather metrics reported periodically over a time window (e.g., daily temperature maximums and minimums), and selecting the maximum and minimum temperatures over that time window. Example re-formatting done at block 512 may comprise, for example, putting time series data values in a first array and corresponding time values in a second array for subsequent use.

Similarly, if at block 508 the backend 303 determines the weather data would process from statistical processing, the backend 303 proceeds to block 514 from block 508 where it performs that processing and then to block 512 where it re-formats the processed data, before proceeding to block 516. In terms of statistical processing performed at block 514, an average or standard deviation of time series data returned by the weather API (e.g., an average temperature or standard deviation of temperature over the time window of data returned by the weather API) may be performed by the backend 303.

At block 516, if the client has requested practice insights, the backend 303 proceeds to block 518 where it finds compatible practices based on the weather data. For example, as described above in respect of the farm profile 900 of FIG. 9, the practice insights may be weather dependent (e.g., no tilling may be recommended in a drought-prone area); the mapping between the weather data in terms of input data and practice insights in terms of output data may be done deterministically or non-deterministically. For example, in at least some embodiments machine learning may be used to perform that mapping non-deterministically. Additionally or alternatively, deterministic, rules-based mapping may be used (e.g., a table of minimum temperatures for respective crops may be mapped against the type of crops the farmer grows, and a practice insight may be a crop recommendation [e.g., rye] if temperatures at the farm stay above the minimum growing temperature for rye [e.g., −18 degrees Celsius]). The backend 303 then proceeds to block 520 where it determines the costs associated with those compatible practices, and then to block 522 where it sends the compatible practices and the weather data to the frontend 302 for display to the user before the method 500 ends at block 524. Alternatively, if practice insights have not been requested, then the backend 303 proceeds from block 516 to block 522 directly where it returns the data (e.g., in JSON format) for the frontend 302 to interpret before the method 500 ends at block 524.

Referring now to FIG. 6, there is shown a flowchart illustrating a method 600 for interacting with a system for estimating agricultural greenhouse gas estimation, according to an example embodiment. More particularly, the method 600 of FIG. 6 may be performed by a CAM responsible for several farmers, and may perform the method 600 using the frontend 302 in order to iteratively improve the emissions estimate for any particular one of the farmers.

The CAM begins performing the method 600 at block 602 and signs into the system 300 at block 604. The CAM may then view statistics associated with their portfolio of farmers at block 606 and select any particular one of the farmers at block 608 via the dashboard 304. If the location of that farmer's farm is already saved in the system database 312 (block 610), the CAM may proceed directly to view that farmer's climate insights and emissions estimations at block 614. Otherwise, the CAM enters the farmer's farm location at block 612 where the backend 303 may obtain climate insights and estimate emissions as described above in respect of FIGS. 4 and 5 before displaying those insights and estimates at block 614. If the CAM wishes to iteratively attempt to improve the emissions estimate (block 616), they may input new data (e.g., they may experiment with different crop or fertilizer types) at block 618 following which the backend 303 re-estimates emissions at block 614. The CAM may iteratively attempt to improve the emissions estimate by changing data and repeating blocks 614, 616, and 618 as desired. Once the CAM is satisfied with the emissions estimate, the method 600 ends at block 620. The CAM may improve the emissions estimate by inputting additional data to progress from one score to a more accurate score. For example, the CAM may begin at an emissions estimate at score 5 and enter additional data at block 618 to improve to score 4; the CAM may similarly improve from score 4 to score 3, and from score 3 to score 2.

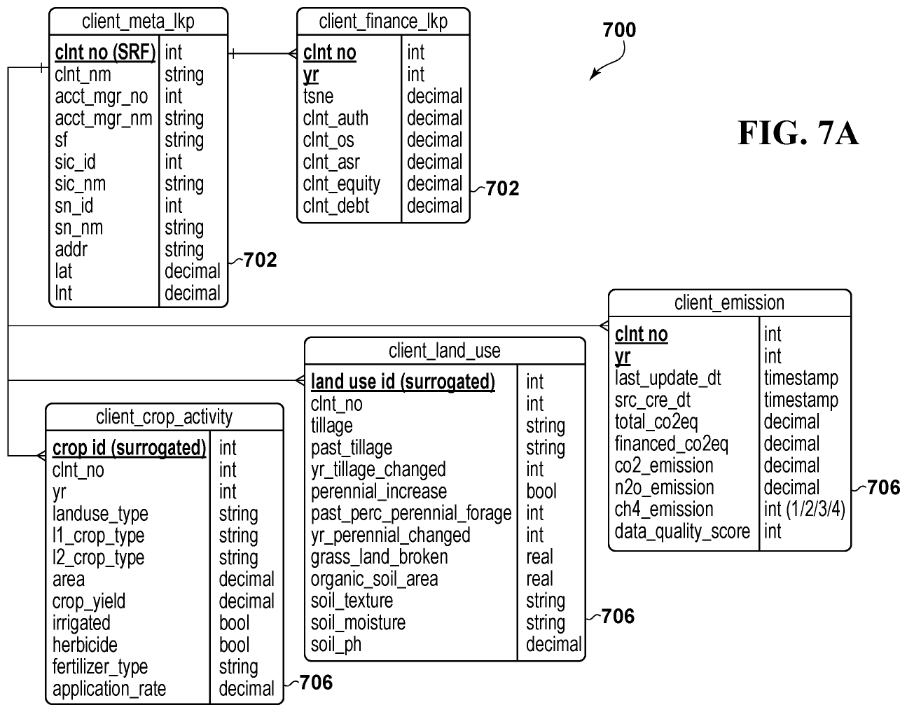

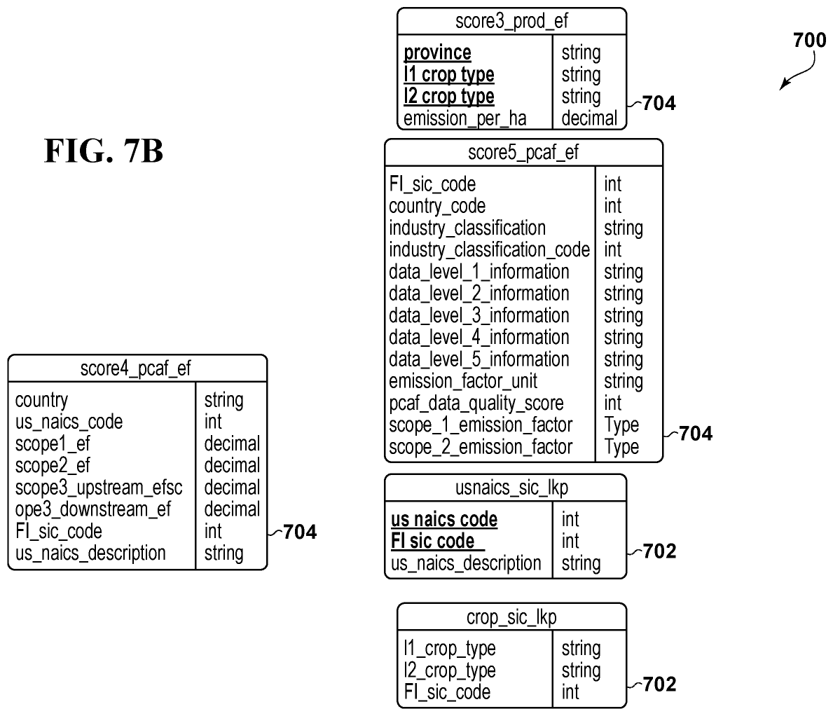

Referring now to FIGS. 7A and 7B, there is shown an entity relationship diagram 700 for the system database 312. Data for entities 702 may come from the FI database 314; data for entities 704 come from external sources such as the weather API 316; and data for entities 706 come from the system 300 itself, such as via the data input form 306. In FIGS. 7A and 7B, the “client_meta_lkp” table comprises meta information about farmers; the “client_finance_lkp” table comprises finance information about farmers; the “client crop activity” table comprises crop information in the form of client crop activity data (e.g., what are farmers planting); the “client_land_use” table comprises information on land use/farm practices (e.g., how do farmers manage their farms); the “client emission” table stores various emission scores determined using data in other tables by applying, for example, Equations (1)-(6); and entities 704 store mapping and emission factors.

Additional embodiments in addition to those described above are also possible. For example, while the frontend 302 and user interface described above are tailored for a CAM, a farmer facing portal may additionally or alternatively be used to allow them to directly log into the system 300 and input and/or share farming data with CAMs. As another example, given a farmer's historical emissions estimates, the system 300 may generate an emissions reductions roadmap to an emissions target. For example, the system 300 may map out an emissions reductions roadmap to a emissions target of “net zero” by a date target of 2050. As another example, the system 300 may automatically populate some of the data required for carbon estimation by leveraging satellite imagery (e.g., crop type; tillage practices, farm area), the weather API 316 (environmental data), and/or by applying natural language processing to the CAMs' annual reports. And as another example, the system 300 may also be certified in the carbon credit market so that emissions reductions at the farm can be monetized and used to offset carbon emissions on other farms and/or other industries altogether.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a processor” or “the processor” does not exclude embodiments in which multiple processors are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Phrases such as “at least one of A, B, and C”, “at least one of A, B, or C”, “one or more of A, B, and C”, and “A, B, and/or C” are intended to include both a single item from the enumerated list of items (i.e., only A, only B, or only C) and multiple items from the list (i.e., A and B, B and C, A and C, and A, B, and C). Accordingly, the phrases “at least one of”, “one or more of”, and similar phrases when used in conjunction with a list are not meant to require that each item of the list be present, although each item of the list may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method for estimating agricultural greenhouse gas emissions, the method comprising:
(a) obtaining farm data comprising at least one of:
(i) revenue generated by a farm;
(ii) crop information for one or more crops grown on the farm; and
(iii) land use/farm practice data for land used on the farm to grow the one or more crops;
(b) determining an emissions estimate in response to the farm data; and
(c) causing the emissions estimate that is determined to be displayed to a user.

2. The method of claim 1, further comprising receiving, from the user, a selection of which of multiple emissions estimates to determine based on the at least one of the revenue generated by the farm, the crop information for the one or more crops grown on the farm, and the land use/farm practice data for land used on the farm to grow the one or more crops, and wherein the emissions estimate that is determined is the emissions estimate selected by the user.

3. The method of claim 1, further comprising obtaining financial information comprising an outstanding amount owing on the farm to a financial institution, total equity in the farm, and total debt on the farm, and wherein the emissions estimate is expressed as a financed emissions estimate based on the financial information and on total emissions representative of emissions financed by the financial institution.

4. The method of claim 3, wherein at least some of the financial information is automatically retrieved from a database of a financial institution that is a creditor of the farm.

5. The method of claim 1, wherein the farm data comprises the land use/farm practice data, and wherein determining the emissions estimate comprises determining at least one of:
(a) direct N₂O emissions from nitrogen from synthetic sources applied to the one or more crops;
(b) direct N₂O emissions from nitrogen from organic fertilizer applied to the one or more crops;
(c) direct and indirect N₂O emissions from nitrogen from manure applied to the one or more crops;
(d) indirect N₂O emissions from nitrogen from biosolids applied to the one or more crops; and
(e) N₂O emissions from organic cultivation of soil used to grow the one or more crops.

6. The method of claim 5, wherein determining the emissions estimate comprises determining all of (a)-(e).

7. The method of claim 5, wherein determining the emissions estimate further comprises determining at least one of:
(a) indirect N₂O emissions from agricultural soils used to grow the one or more crops;
(b) CH₄ and N₂O emissions from burning crop residues of the one or more crops; and
(c) CO₂ emissions from liming and urea applied to the one or more crops.

8. The method of claim 1, wherein the farm data comprises the crop information and excludes the land use/farm practice data, and wherein determining the emissions estimate comprises summing the emissions attributable to each of the one or more crops.

9. The method of claim 1, wherein the farm data comprises the revenue generated by the farm and excludes the land use/farm practice data and the crop information, and wherein determining the emissions estimate is performed using the revenue.

10. The method of claim 1, further comprising:
(a) obtaining, via a wide area network using an application programming interface, weather information customized for a location of the farm;
(b) determining a climate insight for the farm based on the weather information, wherein the climate insight comprises at least one of current and forecasted levels of precipitation in respect of the farm, air temperature at the farm, soil information for the farm, growing degree days for the farm, and years of similar climate or growing conditions to the present or another selected year in respect of the farm; and
(c) causing the climate insight to be displayed to the user.

11. The method of claim 1, further comprising:
(a) obtaining, via a wide area network using an application programming interface, weather information customized for a location of the farm;
(b) determining a practice insight for the farm based on the weather information, wherein the practice insight comprises a recommended farming practice; and
(c) causing the practice insight to be displayed to the user.

12. The method of claim 11, further comprising determining and displaying to the user a cost of implementing the practice insight.

13. The method of claim 1, wherein the crop information comprises at least one of crop type, crop sub-type, and for each type or sub-type at least one of yield, year, acres, fertilizer type, whether an herbicide is used and if so an application rate of the herbicide, and whether the farm is irrigated.

14. The method of claim 1, wherein the land use/farm practice data comprises at least one of past tillage, current tillage, year the past tillage changed to the current tillage, whether there is a perennial crop increase, past percentage of perennial forage, year that perennial forage percentage changed, grass land broken, and organic soil area, soil texture, soil moisture, and soil pH.

15. The method of claim 1, further comprising:
(a) receiving, from the user, different values for the farm data;
(b) in response to each of the different values of the farm data, respectively determining different iterations of the emissions estimate; and
(c) displaying each of the different iterations of the emissions estimate to the user.

16. The method of claim 15, wherein accuracy of the emissions estimate is lowest when based only on the revenue and highest when based on the land use/farm practice data, the different iterations comprise first and second iterations that are based on different types of the farm data, and wherein the emissions estimate of the second iteration is more accurate than the emissions estimate of the first iteration.

17. The method of claim 1, wherein the farm is one of a plurality of farms, and further comprising displaying to the user aggregated emissions data based on the plurality of farms, wherein the aggregated emissions data comprises a graph representing projected emissions for the plurality of farms under different Representative Concentration Pathway scenarios.

18. The method of claim 1, wherein accuracy of the emissions estimate is lowest when based only on the revenue and highest when based on the land use/farm practice data, wherein the farm is one of a plurality of farms, and further comprising displaying to the user a graph of data quality score breakdown indicating aggregate accuracy of the emissions estimates across the plurality of farms.

19. A system for estimating agricultural greenhouse gas emissions, the system comprising:
(a) a display; and
(b) one or more servers communicatively coupled to the one or more databases and the display, and configured to:
(i) obtain farm data comprising at least one of:
(A) revenue generated by a farm;
(B) crop information for one or more crops grown on the farm; and
(C) land use/farm practice data for land used on the farm to grow the one or more crops;
(ii) determine an emissions estimate in response to the farm data; and
(iii) cause the emissions estimate that is determined to be displayed to a user on the display.

20. A non-transitory computer readable medium having stored thereon computer program code that is executable by a processor and that, when executed by the processor, causes the processor to perform a method for estimating agricultural greenhouse gas emissions, the method comprising:
(a) obtaining farm data comprising at least one of:
(i) revenue generated by a farm;
(ii) crop information for one or more crops grown on the farm; and
(iii) land use/farm practice data for land used on the farm to grow the one or more crops;
(b) determining an emissions estimate in response to the farm data; and
(c) causing the emissions estimate that is determined to be displayed to a user.
